(19) United States
(12) Patent Application Publication
(10) Pub. No.: US 2009/0243298 A1
(43) Pub. Date: Oct. 1, 2009

(54) MINIMAL WAVE POWER GENERATOR

(76) Inventors: Philippe F. Jean, Nice (FR); Guillaume A. Ardoise, Nice (FR)

Correspondence Address: LEON D. ROSEN;FREII ICH, HORNBAKER & ROSEN, 10960 Wilshire Blvd., Suite 1220, Los Angeles, CA, 90024, US

(21) Appl. No.: 12/396,979

(22) Filed: Mar. 3, 2009

Related U.S. Application Data
(60) Provisional application No. 61/070,635, filed on Mar. 25, 2008.

(51) Int. Cl. F03B 13/14

(52) U.S. Cl. 290/53; 60/398

(57) ABSTRACT

A system for generating electrical power from sea waves, includes a tube (12) with first and second opposite ends (14, 16), and a membrane assembly (32) that extends across the inside of the tube and that generates electricity when the membrane assembly is deflected. The tube is moored at a fixed height above the seabed so the tube lower end always lies partially or completely below the sea surface. The tube upper end is maintained at a constant pressure, as by providing a sealed gas-filled chamber (30) at the tube upper end. As sea waves pass over the tube, the water pressure at the tube lower end varies, causing the membrane to be deflected so it generates electrical power. In another system, tube opposite ends are horizontally spaced, so as a wave passes over the tube the crest of the wave pressures one tube end at a time to cause membrane deflection.

### CROSS-REFERENCE

Applicant claims priority from U.S. Provisional patent application Ser. No. 61/070,635 filed Mar. 25, 2008.

### BACKGROUND OF THE INVENTION

Electrical power can be obtained from sea waves by taking advantage of the fact that the pressure of the water at a location below the sea surface varies as waves pass over that location. One approach is to use the changes in pressure to move mechanical elements such as pistons, up and down. In almost all cases, the purpose of the power converter is to generate electricity, so reciprocal motion of a piston or other mechanical device is used to drive an electrical generator as by rotating an intermediate mechanical device. U.S. Pat. No. 6,140,712 describes a device of this type. An electricity-generator system that minimized the mass and complexity of devices for converting mechanical energy to electrical energy would be of value.

### SUMMARY OF THE INVENTION

In accordance with one embodiment of the invention, a wave power generator system of low mass and complexity is provided that uses waves to generate electricity. The system uses a deflectable membrane assembly that comprises a membrane of electroactive material that generates electricity when it is deflected. The membrane assembly extends across and seals the inside of a tube to allow different pressures to exist at the opposite ends of the tube. The tube is anchored to the seabed so a first end of the tube lies at a constant height above the seabed and therefore experiences changes in water pressure as waves move over it. The second end of the tube is maintained at a pressure that is different from the pressure at the first end. In one system, the second end of the tube connects to a gas-filled chamber that is at a constant pressure. When the crest of a wave passes over the tube, the pressure at the first end increases while the pressure at the second end does not change, so the membrane deflects towards the tube second end and generates electricity. When the trough of the wave passes over the tube, the pressure at the tube first end decreases so the membrane deflects towards the tube first end. In most cases, the tube first end which is open to changing water pressure, is the lower end of the tube so it is constantly submerged.

In another system, The opposite ends of the tube are both underwater, and are horizontally spaced. When the crest of a wave passes over a first end of the tube, the water pressure increases at that end and the membrane moves away from the tube first end. When the trough of the wave passes over the first end, the water pressure at that end decreases and the membrane moves towards that tube end. The horizontal spacing of the tube ends are preferably at least one quarter wavelength, and more preferably at least one half wavelength, of the average length of sea waves in that area.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a sectional side view of a wave power generating system of the invention wherein the upper end of an acceleration tube is connected to a gas pressure source of constant pressure, and with the tube shown lying under a mid wave location halfway between the wave crest and trough.

FIG. 2 is a sectional view of the system of FIG. 1, with the tube lying under the crest of a wave.

FIG. 3 is a sectional view of the system of FIG. 1, with the tube lying under the trough of the wave.

FIG. 4 is a sectional view of a system of another embodiment of the invention, wherein the upper side of the membrane is exposed to the pressure of the atmosphere plus the weight of a water column.

FIG. 5 is a partial sectional view of a deflectable membrane used with the invention, which generates electricity when deflected.

FIG. 6 is a sectional side view of a wave power generating system of another embodiment of the invention, wherein the opposite ends of an acceleration tube are horizontally spaced.

FIG. 7 is a sectional side view of a wave power generator system of another embodiment of the invention which includes two vertical acceleration tubes with ends lying near the sea surface.

FIG. 8 is a section side view of another system that includes horizontal tubes wherein one lies near the sea surface.

FIG. 9 is a sectional side view of another system that includes tubes each lying at an incline to the horizontal.

### DESCRIPTION OF THE PREFERRED EMBODIMENTS

FIGS. 1-3 show a wave power generating system 10 of the invention, which includes an acceleration tube 12 that has first and second opposite ends 14, 16. The tube is held with its first end 14 at a predetermined height above the sea bed 20, by a float 22 that urges it upward in the water and by mooring lines 24 that limit its upward movement. The tube first end 14 is lowermost and is open to the sea. The tube second end 16 is maintained at a substantially constant pressure (but variable volume) by connecting it to a closed air-filled, or gas-filled chamber 30. A membrane assembly 32 extends across the tube, and is deflected when the pressure between the tube opposite ends changes.

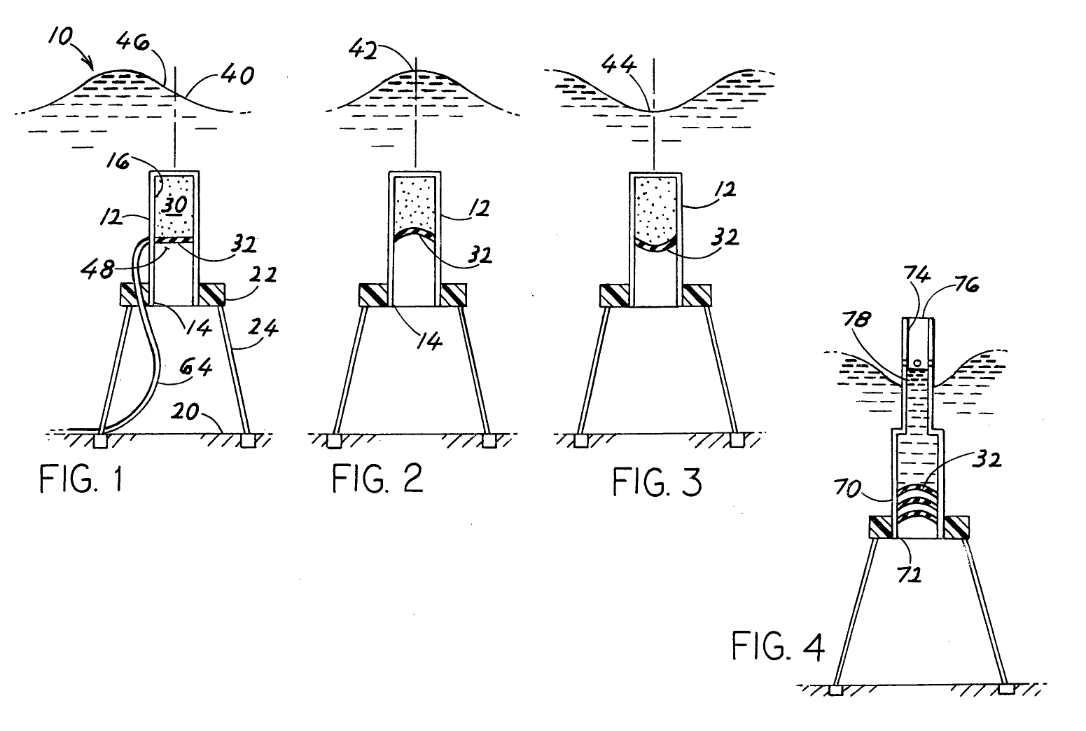

Sea waves 40 move across the sea surface above the tube. FIG. 2 shows the crest 42 of a wave lying above the tube, which is when the water pressure at the tube first or lower end 14 is greatest. The water pressure is greatest in FIG. 2 because the height of water between the tube lower end 14 and the wave crest is greatest. The increased pressure at the tube lower end results in the membrane 32 deflecting upward, as shown. FIG. 3 shows the trough 44 of a wave lying above the tube, which is when the water pressure at the tube second or lower end is a minimum. Then, the membrane 32 deflects downward, as shown. FIG. 1 shows a wave middle 46, which is of a height halfway between the crest and trough, lying above the tube. The constant pressure in the tube second end 16 is equal to water pressure at a location 48 immediately under the membrane when the wave middle 46 lies over the tube. As a result, the membrane deflects in opposite directions as the wave crest and wave trough move over the tube. A spring or weight can lie in the tube second end to minimize the required gas pressure in the tube second end.

The membrane assembly 32 includes a prior art membrane of electroactive material that generates electricity when its deflection changes while an electric field is being applied. FIG. 5 shows that the membrane assembly 32 includes a layer or membrane 50 of synthetic stretchable material such as a flexible electroactive polymer. A pair of electrodes 52, 54 lie against opposite faces of the layer and apply an electric field to the material. Such electric field is required to produce electric power when the membrane deflects. A pair of sealing films 60, 62 lie against opposite faces of the electrodes to seal them against contact with sea water. Greatest membrane deflection and power output generally occurs when the membrane deflects in opposite directions. However, power is obtained when the membrane direction of deflection does not change but the amount of deflection in that direction varies.

As waves move above the acceleration tube 12 of FIGS. 1-3, and the membrane assembly 32 deflects, the membrane assembly creates electricity which is carried away though a cable 64. Although only one membrane assembly 32 is shown in the tube, a plurality of membrane assemblies can be used that lie one above the next to obtain a greater amount of electricity from the system. While the first end 14 of the tube that is open to the sea is shown as the lowermost end, the first end 14 can lie at the top of the tube or halfway between the top and bottom (when the tube extends horizontally). The main criteria is that the tube first end 14 is open to the sea and at a constant height above the seabed, so water pressure at the tube first end varies as waves move over the tube, while the tube second end 16 is at a constant pressure. In the embodiment of FIGS. 1-3 the tube is located so the lower end 14 is covered with water at least 90% of the time, and preferably 100% of the time that the system is being used to generate electricity.

FIG. 4 illustrates another acceleration tube 70 with a first end 72 that is open to water, and with a second end 74 that is at a constant pressure. The second end has a top 76 that lies above the sea, and above most waves, so it is exposed to environmental air pressure, which is constant. In order to produce a pressure at the upper side of the membrane 32 that is approximately equal to water pressure at the lower side of the membrane assembly at the middle of a wave, a column of water 78 lies in the tube second end below the top 74 that is open to the atmosphere. It is possible to use a spring or a number of other approaches to pressurize the tube upper end.

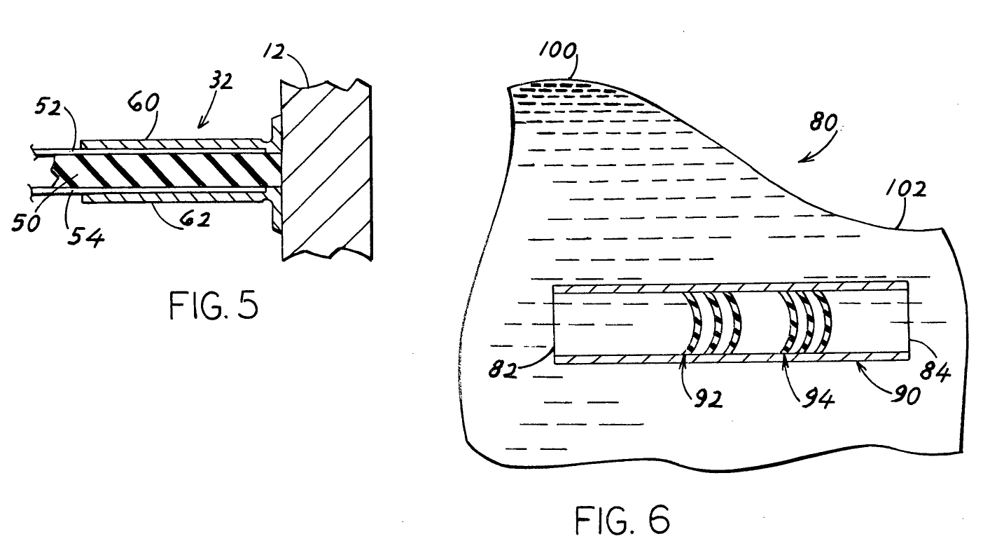

FIG. 6 illustrates another wave power generating system 80 which relies on the difference in water pressure above opposite ends 82, 84 of a largely horizontal acceleration tube 90. Both ends 82, 84 of the tube are open to the sea. Groups 92, 94 of membrane assemblies that generate electricity when their deflection is changed, extend across the tube at a location between the tube ends. FIG. 6 shows a situation where the horizontal tube length is approximately equal to one half of the wave length of sea waves, at an instant when the wave crest 100 lies over one tube end 82 and the wave trough 102 lies over the opposite tube end 84. This results in a large difference in water pressure across the membrane groups 92, 94 resulting in a large deflection of the membranes and the generation of a large amount of electricity. The horizontal length of the tube 90 preferably equals at least a quarter wavelength, and preferably at least one-half wavelength of the average (e.g. median) sea wave length in the area of the system 80. This results in the tube opposite ends often lying under wave locations of considerably different heights. It is possible to construct the tube 90 so its length varies as the sea wave length varies. It would be possible to open only one tube end such as 82 to the sea, and to maintain a predetermined pressure (e.g. gas pressure) in the tube opposite end 84.

The length of sea waves varies with sea location, weather, season and many other factors. Offshore wavelengths commonly vary between 10 meters and 200 meters. Applicant prefers to use tubes of a length of at least a quarter wavelength of sea waves, and at least 2.5 meters length.

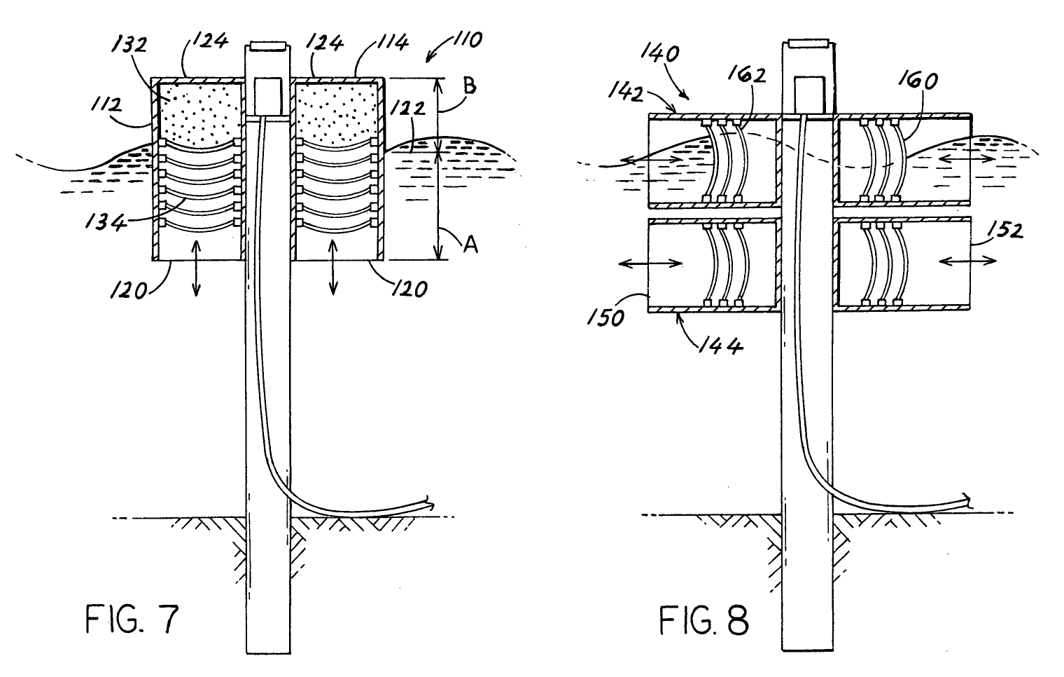

FIG. 7 illustrates a system 110 with a pair of acceleration tubes 112, 114 having lower ends 120 lying a small distance A under the mid sea surface level 122 and having closed upper ends 124 that lie a small distance B above the sea surface. The tube upper end is closed (although it can be occasionally opened to environmental air). Trapped air lies at 132 in the tube. There is about the same pressure at the bottom of the membranes 134 as at the top of the membranes. The membranes deflect as the crest and trough of sea waves pass by, or over the tubes.

FIG. 8 illustrates a system 140 wherein a pair of acceleration tubes 142, 144 with horizontally spaced open ends 150, 152 are moored in the sea. One of the tubes 142 may be only partially immersed while the other is completely immersed at least 90% of the time. The membrane groups 160, 162 of both tubes undergo changes in deflection as waves pass across them.

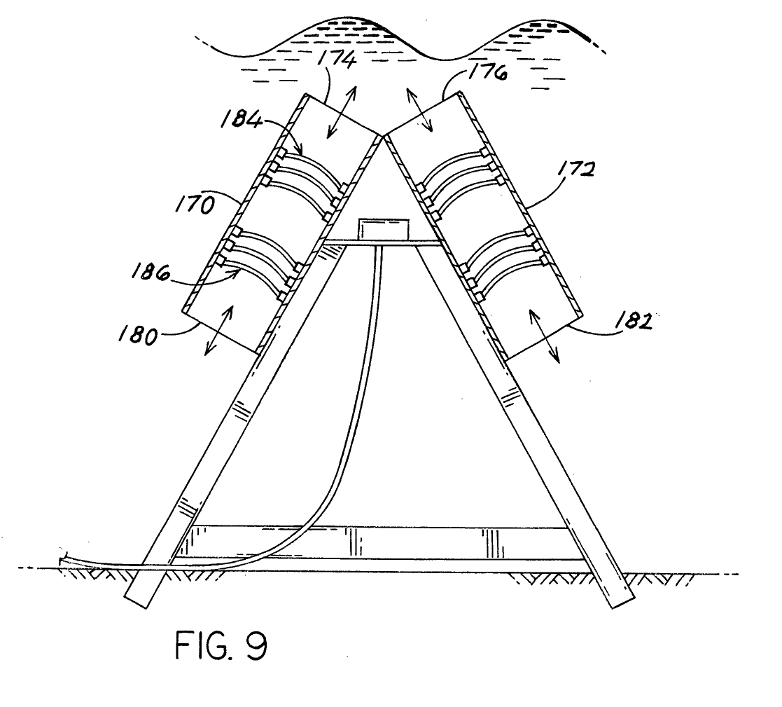

FIG. 9 illustrates a system fixed to the seabed, which includes two acceleration tubes 170, 172 that have adjacent first tube open ends 174, 176, and that extend at downward inclines away from each other. The tubes have opposite open second tube ends 180, 182 that lie at a greater depth and that are horizontally spaced from the first tube ends. The pressure at the tube lower ends 180, 182 will be greater than at the upper ends. The difference in pressures will change as the height of each wave part passes over each end of a tube, and as different parts of a wave pass over the different ends of a tube. Alternatively, the tube first ends 174, 176 can be closed so air is trapped between each tube upper end and the membranes 184, 186.

Thus, the invention provides systems for generating electricity which are of low mass and low complexity. The systems include membrane assemblies with membranes that generate electricity when their deflection changes. Each membrane assembly lies within and is sealed across a tube that is moored to lie a predetermined distance above the seabed. A first end of the tube is open to the sea, so the pressure of the sea thereat varies as sea waves pass over the tube first end. The opposite second end of the tube is at a pressure that is different from the pressure at the first end at least some of the time. In one system, the second end of the tube is at a constant pressure, as where the tube second end contains gas under pressure. In a variation, the tube second end contains a spring or the weight of a column of sea water with an upper end open to the atmosphere. The difference in pressure at opposite ends of the membrane assembly, causes changes in membrane deflection and consequent generation of electricity. In another system, opposite ends of the tube are horizontally spaced, so most of the time different heights of a sea wave lie over the different ends. The changes in the differences in heights of the waves cause changes in deflection of the membrane to generate electricity.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A wave power generating system (10, 80) comprising:
a tube (12, 70, 90, 112, 144, 170, 172) that is moored in a sea to lie a predetermined distance above the seabed (20);
said tube having first and second opposite ends (14, 16, 72, 74, 82, 84, 120, 124, 150, 152, 174, 176, 180, 182) with said tube first end (14, 72, 82, 120, 150, 180, 182) open to the sea so the pressure of sea water at said tube first end varies as waves pass over said tube first end, and with said tube second end (16, 74, 84, 124, 152, 174, 176) being at a pressure that is different from the pressure at said tube first end some of the time;
at least one deflectable membrane assembly (32, 92, 94, 136, 160, 162) sealed to said tube and extending across an inside of said tube at a location lying between said tube ends, to be deflected by the difference in pressure at said tube opposite ends, said deflectable membrane assembly (50) comprising a membrane of electroactive material which generates electricity when it is deflected.

2. The system described in claim 1 including:
said tube first end lies below wave level at least 90% of the time, and said tube second end is exposed to gas (30, 132) at a constant pressure.

3. The system described in claim 1 wherein:
said tube first end lies primarily below said tube second end.

4. The system described in claim 1 wherein:
said tube second end is closed and contains gas (30, 132) at a predetermined pressure.

5. The system described in claim 1 wherein:
said tube second end (74, 152) is open to the atmosphere that lies above the sea surface.

6. The system described in claim 1 wherein:
said tube first and second ends (150, 152, 174, 176, 180, 182) are horizontally spaced so a line connecting them is inclined no more than 45° from the horizontal, and said tube ends are each exposed to the sea at a location beneath the trough of waves at least 90% of the time.

7. The system described in claim 1 wherein surface waves at the location of said tube have a predetermined average wave length, and wherein:
said first and second tube ends are spaced apart by at least one-quarter of said predetermined wavelength.

8. A system for generating electrical power from surface waves in a sea, by obtaining power from a membrane assembly (32, 134) that includes a deflectable membrane (150) with electroactive material thereon which generates electricity when it is deflected, comprising:
a primarily vertical tube (12, 70) with a lower end (14, 72, 120, 180, 182) moored at a predetermined height above the sea floor that keeps the lower end constantly submerged, said lower end being open to the sea;
said tube having an upper end (16, 74, 124, 174, 176) which is exposed to a constant pressure;
said membrane assembly (32, 134) extending across an inside of said tube, at a location between said tube ends to be deflected by a difference in pressure at said ends.

9. The system described in claim 8 wherein:
said tube upper end is exposed to gas that is at a constant pressure.

10. A system for generating electrical power from surface waves in a sea, by obtaining power from a membrane assembly that includes a deflectable membrane that has electroactive material thereon which generates electricity when it is deflected, comprising:
a tube (90, 144, 170, 172) with opposite ends (82, 84, 150, 152, 174, 176, 180, 182) that are horizontally spaced, at least one end of said tube being open to the sea.

11. The system described in claim 10 wherein:
said tube opposite ends are both open to the sea.

12. A method for generating electrical power from surface waves in a sea, by obtaining power from a membrane assembly that includes a deflectable membrane that has electroactive material thereon which generates electricity when it is deflected, comprising:
mounting said membrane assembly in a tube between first and second ends of the tube so a difference in pressure between said tube ends deflects said membrane, mooring the tube so its first end lies at a predetermined height above the sea floor that keeps said first end submerged in the sea at least 90% of the time, and exposing said tube second end to gas at a constant pressure.

13. The method described in claim 12 wherein:
said step of exposing said tube second end to gas at a constant pressure comprises forming a closed gas-filled chamber at said tube second end.

14. The method described in claim 12 wherein:
said step of exposing said tube second end to gas at a constant pressure comprises exposing said tube second end to the atmosphere.
